(19) United States
(12) Patent Application Publication
(10) Pub. No.: US 2019/0298102 A1
(43) Pub. Date: Oct. 3, 2019

(54) FULLY-AUTOMATIC SPIRAL WATER-DISCHARGING STRUCTURE FOR COFFEE POT

(71) Applicant: Guangdong Homezest Tech. Co., LTD, Guangdong (CN)

(72) Inventors: Qianggao Zheng, Guangdong (CN); Chunyu Liu, Guangdong (CN); Bixin Hou, Guangdong (CN); Xiaoyi Zhou, Guangdong (CN); Lijun Min, Guangdong (CN)

(21) Appl. No.: 16/343,851

(22) PCT Filed: Jun. 1, 2017
(86) PCT No.: PCT/CN2017/086883

§ 371 Date: Apr. 22, 2019

(30) Foreign Application Priority Data
Oct. 25, 2016 (CN) 201610955388.X

(51) Int. Cl. A47J 31/46; A47J 31/50; A47J 31/057; A47J 31/10

(52) U.S. Cl. CPC A47J 31/467; A47J 31/10; A47J 31/0573; A47J 31/50

(57) ABSTRACT

An automatic coffee pot helical launch structure includes a base body and motor installed in the base body, a concave-upward chamber, in which an inner turntable gear and an outer turntable gear are disposed, installed on the bottom surface of the base body, an outlet being installed through the inner turntable gear axially a center gear extending downward from the middle of the top wall of the base body's chamber, the center gear meshes with inner turntable gear, which sleeves inside the eccentric hole of the outer turntable gear and rotates around the shaft, a water inlet through the base body installed in the center gear axially, wherein the motor drives the outer turntable gear through the motor gear, and wherein the inner turntable gear whose upper surface is concave-downward is arranged below the water inlet.

### TECHNICAL FIELD

This invention refers to a field of coffee machine, particularly an automatic coffee pot helical launch structure.

### BACKGROUND TECHNOLOGY

Among the existing technology, in order to complete coffee extraction ,the boiling water in the coffee machine is generally dripped from a fixed a position to the coffee powder, the coffee powder will be mixed with water and dissolved when the boiling water passes through the coffee powder, and then the soluble substances in the coffee powder will be taken out. However, because the position of boiling water through the coffee powder is fixed, the soluble substances will not be supplemented once part of that in the position are taken away, while the soluble substances in other positions are not effectively utilized, which will affects the extraction rate of coffee.

### SUMMARY

The aim of our invention is to solve the technical issues mentioned above, that is , to provide an automatic coffee pot helical launch structure which makes water be in uniform contact with the coffee powder in all positions and then improves the extraction rate of the coffee.

The technical scheme adopted for achieving the purpose mentioned above, comprises the following parts: An automatic coffee pot helical launch structure is consist of base body and motor installed in the base body. There is a concave-upward chamber, in which an inner turntable gear and an outer turntable gear are disposed, installed on the bottom surface of the base body. There is a center gear extending downward from the middle of the top wall of base body's chamber. The center gear meshes with inner turntable gear, which sleeves inside the eccentric hole of the outer turntable gear and rotates around the shaft. The motor drives the outer turntable gear through the motor gear. There is a water inlet through the base body installed in the center gear axially. The inner turntable gear whose upper surface is concave-downward is arranged below the water inlet. There is also a outlet installed through the inner turntable gear axially. When the motor is working, the inner turntable gear rotates not only around the rotation axis of the outer turntable gear, but also around the central gear due to the transmission of gear, so that the water outlet on the inner turntable gear can move along the spiral trajectory. When water flows into the inner turntable gear through the water inlet on the center gear, and then the water is spiral out of the water outlet, which causing that the water is in uniform contact with the coffee powder in all positions and the utilization of soluble substances in coffee powder is increased, so that the extraction rate of the coffee is improved.

Furthermore, there is an annular positioning plate installed in the orifice of base body's chamber. And the outer turntable gear is sleeved in the center hole of the annular positioning plate.

Furthermore, the motor is installed on one side of the base body, through which the shaft of the motor is connected to the motor gear, which is located between base body and the annular positioning plate.

Furthermore, there is an annular step arranged inside the inner side wall of the base body, and the outer turntable gear is sandwiched between the annular step and the annular positioning plate.

Furthermore, the center gear is arranged around the same axis with the annular positioning plate.

Furthermore, the inner turntable gear is sandwiched between the top wall of base body's chamber and the outer turntable gear.

Furthermore, the teeth of the inner turntable gear which are arranged on the inner hole, mesh with the center gear.

Furthermore, the teeth of the inner turntable gear are arranged on the outer-circle of the turntable. Besides, there is a reduction gear, which meshes with the inner turntable gear and center gear, arranged inside the outer turntable gear.

Each of the above “Furthermore” is deemed as one example. Each of the examples can not only be used alone as an embodiment, but also be used as combined embodiment by any combination of embodiments without any contradiction.

### BRIEF DESCRIPTION OF THE DRAWINGS

FIG. 1 refers to the structure schematic of the first embodiment.

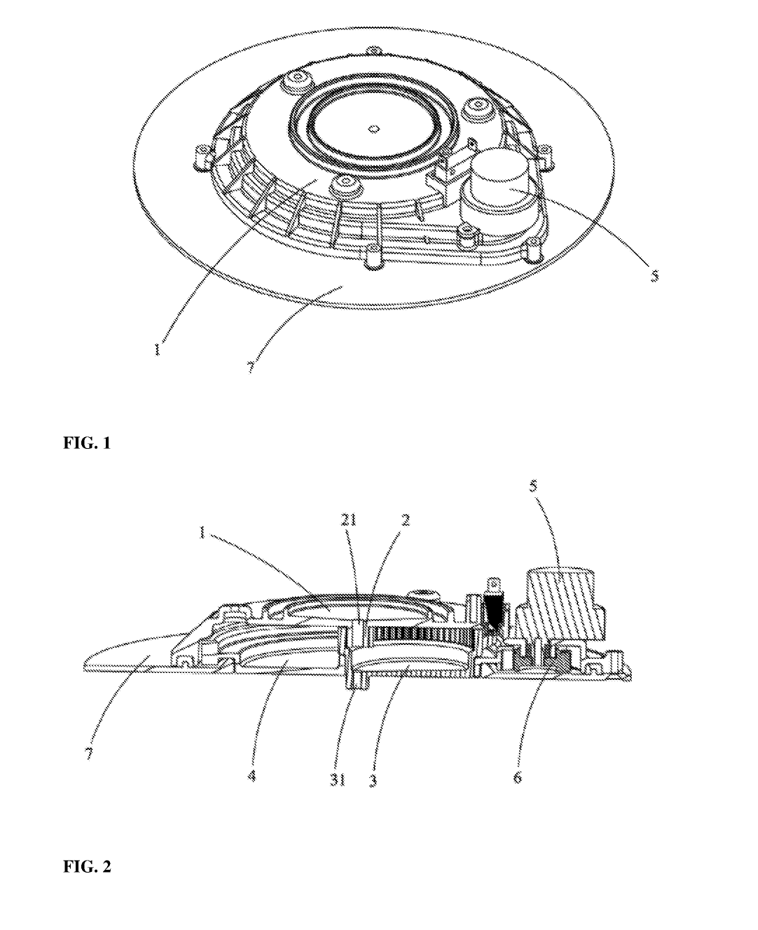

FIG. 2 refers to the structure cutaway view of the first embodiment.

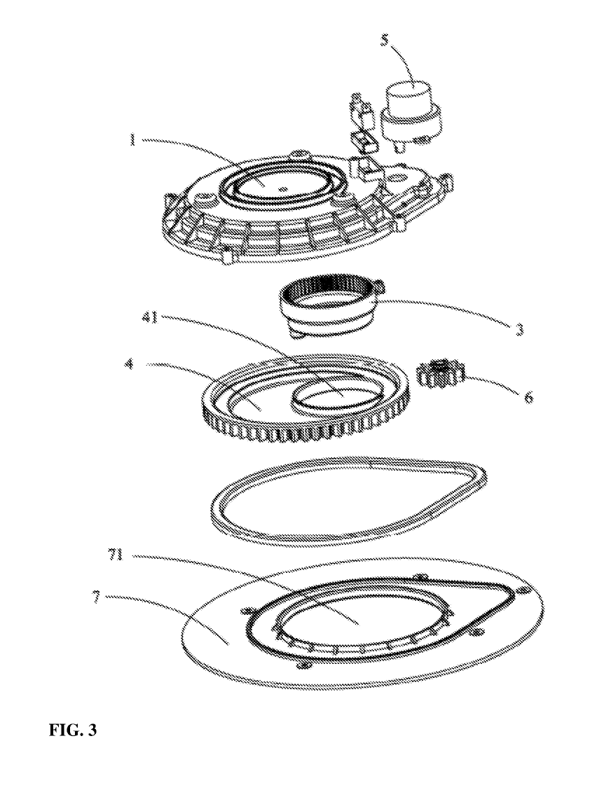

FIG. 3 refers to the structure assembly diagram of the first embodiment.

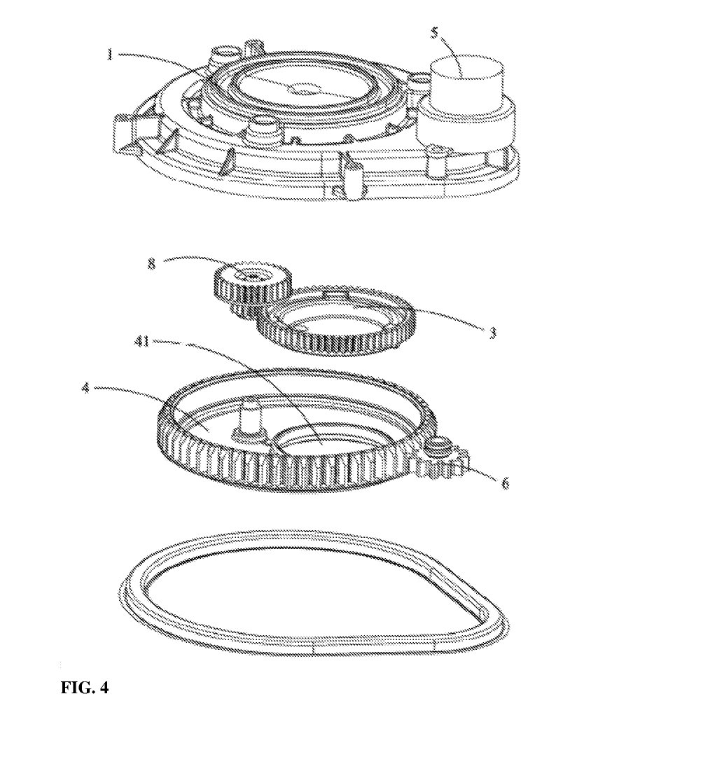

FIGS. 4 & 5 refer to the structure assembly diagram of the second embodiment.

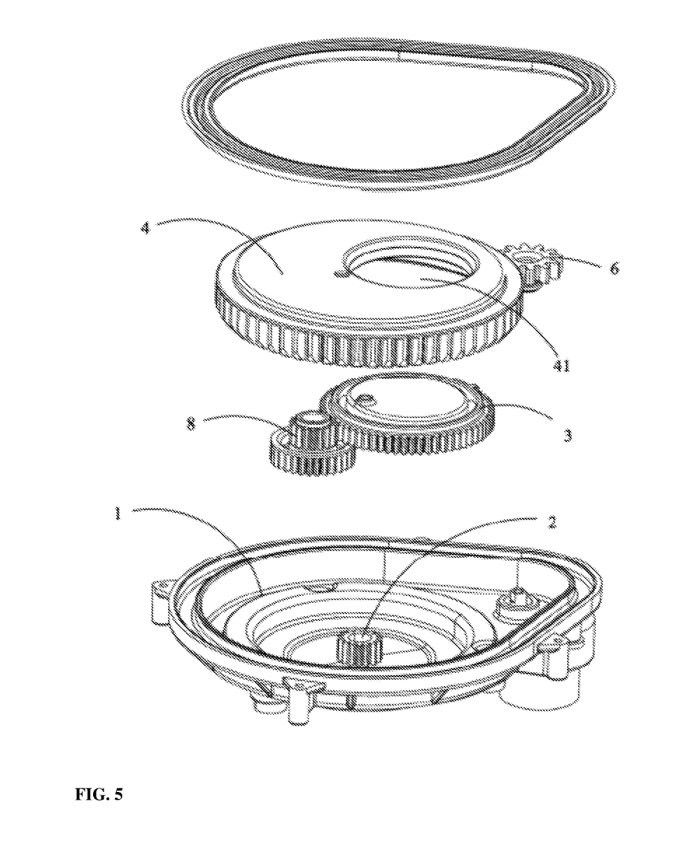

### DETAILED DESCRIPTION

Hereinafter, we will describe the embodiments of our invention in detail. Examples of the embodiments are shown in the attached drawings with the same or similar reference numerals to denote the same or similar components or components performing the same or similar functions. The embodiments described below with reference to the drawings are exemplary only to explain the invention, which cannot be interpreted as the limitation on our invention. On the contrary, the embodiments of our invention comprises all changes, modifications, and equivalents in compliance with the spirit and content of the claims.

As shown in drawing 1 & 2, the said embodiment comprises base body 1 and motor 5 installed in one side of the base body 1. There is a concave-upward chamber, in which an inner turntable gear 3 and an outer turntable gear 4 are disposed, installed on the bottom surface of the base body 1. There is a center gear 2 extending downward from the middle of the top wall of base body's chamber. The center gear 2 meshes with inner turntable gear 3, which sleeves inside the eccentric hole of the outer turntable gear 4 and rotates around the shaft. The shaft of the motor is connected through the base body 1 to the motor gear 6, which drives the outer turntable gear 4. There is a water inlet 21 through the base body 1 installed in the center gear 2 axially. The inner turntable gear 3 whose upper surface is concave-downward is arranged below the water inlet 21. There is also a water outlet 31 installed through the inner turntable gear 3 axially.

The center gear 2 is arranged around the same axis with the annular positioning plate 7, which installed in the orifice of base body's chamber. the outer turntable gear 4 sleeves in the center hole 71 of the annular positioning plate 7. There is an annular step 11 arranged inside the inner side wall of the base body 1, and the outer turntable gear 4 is sandwiched between the annular step 11 and the annular positioning plate 7. The said inner turntable gear 3 is sandwiched between the top wall of base body's chamber and the outer turntable gear 4. The motor gear 6 is located between base body 1 and the annular positioning plate 7.

The teeth of the inner turntable gear 3 which are arranged on the inner hole of the turntable, mesh with the center gear 2.

As shown in drawing 4 & 5, the teeth of the inner turntable gear 3 are arranged on the outer-circle of the turntable. In addition, there is a reduction gear 8, which meshes with the inner turntable gear and center gear 2, arranged inside the outer turntable gear 4.

When our invention is working, the motor 5 drives the outer turntable gear 4 to rotate through the motor gear 6. At this time, the inner turntable gear 3 rotates not only around the rotation axis of the outer turntable gear 4, but also around the central gear 2, so that the water outlet 31 on the inner turntable gear 3 can move along the spiral trajectory. When water flows into the inner turntable gear 3 through the water inlet 21, and then the water is spiral out of the water outlet 31, which causing that the water is in uniform contact with the coffee powder in all positions and the utilization of soluble substances in coffee powder is increased, so that the extraction rate of the coffee is improved.

1. An automatic coffee pot helical launch structure comprising:
a base body and motor installed in the base body;
a concave-upward chamber, in which an inner turntable gear and an outer turntable gear are disposed, installed on a bottom surface of the base body, an outlet installed through the inner turntable gear axially;
a center gear extending downward from the middle of a top wall of the base body's chamber the center gear meshes with inner turntable gear, which sleeves inside an eccentric hole of the outer turntable gear and rotates around a shaft; and
a water inlet through the base body installed in the center gear axially
wherein the motor drives the outer turntable gear through a motor gear, and
wherein the inner turntable gear whose upper surface is concave-downward is arranged below the water inlet.

2. The automatic coffee pot helical launch structure according to claim 1, further comprising an annular positioning plate installed in an orifice of the base body's chamber, wherein the outer turntable gear is sleeved in a center hole of the annular positioning plate.

3. The automatic coffee pot helical launch structure according to claim 2, wherein the motor is installed on one side of the base body, through which the shaft of the motor is connected to the motor gear which is located between base body and the annular positioning plate.

4. The automatic coffee pot helical launch structure according to claim 2, further comprising an annular step arranged inside an inner side wall of the base body, wherein the outer turntable gear is sandwiched between the annular step and the annular positioning plate.

5. The automatic coffee pot helical launch structure according to claim 2, wherein the center gear is arranged around the same axis with the annular positioning plate.

6. The automatic coffee pot helical launch structure according to claim 1, wherein the inner turntable gear is sandwiched between a top wall of the base body's chamber and the outer turntable gear.

7. The automatic coffee pot helical launch structure according to claim 1, wherein teeth of the inner turntable gear which are arranged on the inner hole, mesh with the center gear.

8. The automatic coffee pot helical launch structure according to claim 1, further comprising teeth of the inner arranged on the outer-circle of the inner turntable gear; and a reduction gear, which meshes with the inner turntable gear and center gear, and arranged inside the outer turntable gear.
